(19) United States
(12) Patent Application Publication
(10) Pub. No.: US 2006/0253795 A1
(43) Pub. Date: Nov. 9, 2006

(54) System and method and application program interface for scrolling

(75) Inventors: Dmitry G. Titov, Redmond, WA (US); Gregory A. Lett, Redmond, WA (US); Henry D. Hahn, Bellevue, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/122,936

(22) Filed: May 5, 2005

(51) Int. Cl. G06F 3/00

(52) U.S. Cl. 715/786; 715/787

(57) ABSTRACT

System, method and API for scrolling in a GUI. Scroll-able content to be displayed in a viewport can include information to control parameters used in scrolling. These parameters can include one or more of the following: the size of the viewport that can be scrolled; whether the content can be scrolled vertically and/or horizontally; the amount of un-rendered content (i.e., content not visible in the “scrollable” viewport) to be prepared for rendering (de-virtualized), etc. The system can include a first object to handle information regarding the content to be displayed in the “scrollable” viewport and a second object to handle user input of the GUI and provide it to the first object.

### TECHNICAL FIELD

Embodiments of the present invention relate to methods and systems and interfaces to display content and, more particularly to displaying content with a scrolling mechanism.

### BACKGROUND

Graphical user interfaces (GUIs), web pages, etc. commonly include a scrolling functionality to allow a user to view content that is too large to be viewed in a provided space. In one conventional approach, a developer can include scrolling functionality in an application. However, the developer is typically limited in the scrolling parameters that can be specified, which may not meet the developer's needs with regard to application requirements.

### SUMMARY

According to aspects of various described embodiments, systems, methods and application program interfaces (APIs) for scrolling are provided. In one aspect, content to be scroll-ably displayed in a viewport can include information to control parameters used in scrolling and include a scrolling implementation itself. The information can be used to enable a scrollbar control used for scrolling content to show itself in the correct configuration. For example, one implementation of a scrollbar contains a UI element called a “thumb” that allows the user to scroll to an arbitrary location in scrollable content. The size of the thumb can be used to indicate how much content is viewable proportional to the amount of scrollable content. This size can be determined by information provided by the scrollable content. The scrolling implementation defined by the content can allow a generic scrolling controller to work with content with a specific method of scrolling. For example, if the scrollable content provides a scrolling implementation, it may desire to scroll by an amount commensurate with the size of the viewport upon user interaction with the scrolling controls.

In this way, a given scrolling controller can be re-used with many different types of scrollable content while specific requirements of scrolling for that content is enabled.

Embodiments may be implemented as a computer process, a computer system (including mobile handheld computing devices) or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is a diagram illustrating an exemplary system for displaying content using a scrolling feature, according to one embodiment.

FIG. 2 is a diagram illustrating a viewport with scrollbars and dimensions related to the scrollbars and the content, according to one embodiment.

FIG. 3 is a diagram illustrating one embodiment of a tree of elements in order to scroll content.

FIG. 4 is a flow diagram illustrating operational flow in creating elements described in FIG. 3, according to one embodiment.

FIGS. 5 and 5A are flow diagrams respectively illustrating operational flow of a scrolling implementation responding to content changes and user input, respectively, according to one embodiment.

FIG. 6 is a block diagram illustrating an exemplary computing environment for implementing a scrolling feature, according to one embodiment.

### DETAILED DESCRIPTION OF ILLUSTRATED EMBODIMENTS

Various embodiments are described more fully below with reference to the accompanying drawings, which form a part hereof, and which show specific exemplary embodiments for practicing the invention. However, embodiments may be implemented in many different forms and should not be construed as limited to the embodiments set forth herein; rather, these embodiments are provided so that this disclosure will be thorough and complete, and will fully convey the scope of the invention to those skilled in the art. Embodiments may be practiced as methods, systems or devices. Accordingly, embodiments may take the form of an entirely hardware implementation, an entirely software implementation or an implementation combining software and hardware aspects. The following detailed description is, therefore, not to be taken in a limiting sense.

The logical operations of the various embodiments are implemented (1) as a sequence of computer implemented steps running on a computing system and/or (2) as interconnected machine modules within the computing system. The implementation is a matter of choice dependent on the performance requirements of the computing system implementing the embodiment. Accordingly, the logical operations making up the embodiments described herein are referred to alternatively as operations, steps or modules.

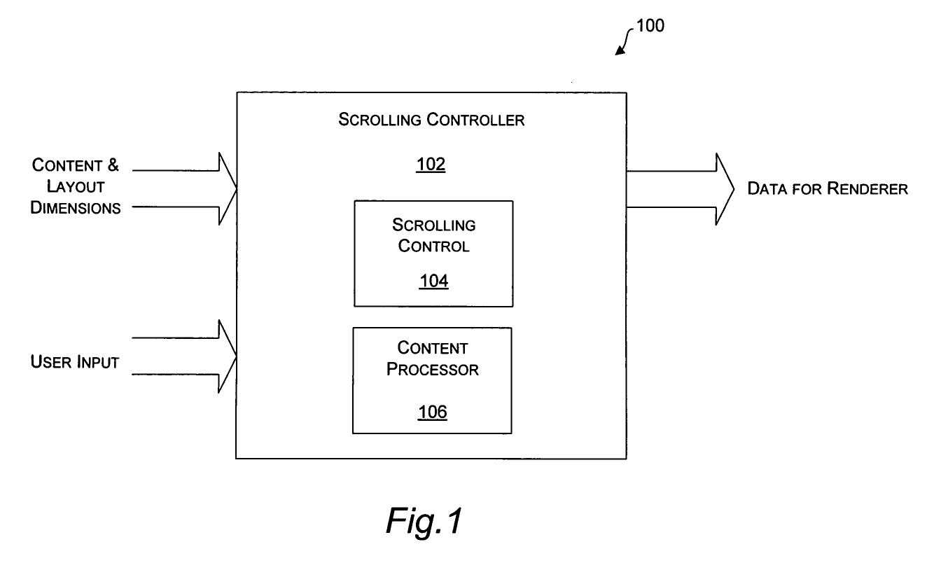

FIG. 1 illustrates an exemplary system 100 with a scrolling implementation that can be specified by the content, according to one embodiment. In this embodiment, system 100 includes a scrolling controller102 that in turn includes a scrolling control 104 and a content processor 106 that is used to support scrolling of content in a GUI. Scrolling controller 102 can be incorporated into an operation system or application such as, for example, a web browser, a word processor, an email application, a calendaring application, etc.

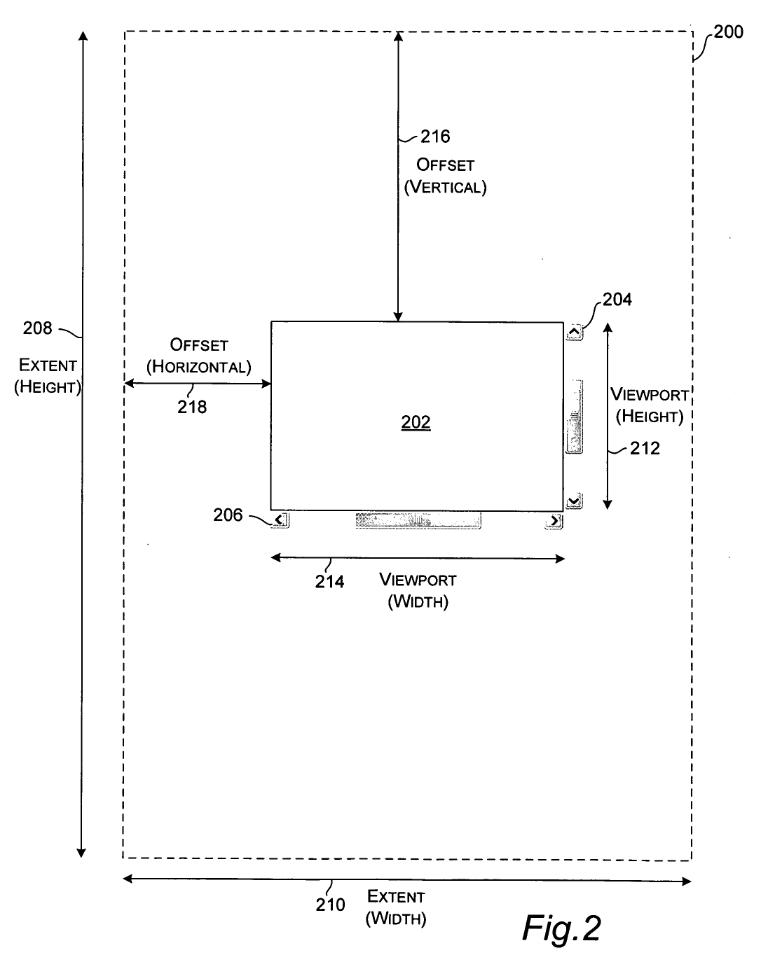

In operation, scrolling controller 102 receives content to be displayed in a viewport (not shown) with scrolling controls that allow a user to scroll the content, and the dimensions of the viewport, content size (i.e., “extent”), and “offset” between the content and viewport (illustrated in FIG. 2, which is described below). In one embodiment, the content and viewport dimensions are received from a layout service implemented by the application or platform generating the GUI. Thus, this dimension information is also referred to herein as layout information (which may include other information in addition to the dimensions of the offset, viewport and extent. In addition, scrolling controller 102 also receives user input in this embodiment. The user input includes input generated by the user in operating scrolling controls, such as scroll bars, presented in the GUI.

Scrolling controller 102, in this embodiment, provides scrolling controls that are presented in the GUI adjacent to the viewport. In one embodiment, the scrolling controls may be scrollbars while in another embodiment have other scrolling controls instead of or in addition to scrollbars. The developer of the GUI may allow users to control or select a style for a scrolling control (i.e., the appearance of the scrollbar).

Content processor 106 processes the content, including: (a) making the appropriate portion of the content visible within the viewport; (b) de-virtualizing the appropriate portion(s) of the content (i.e., “de-virtualized” content refers to a portion of content that is prepared to be rendered or displayed but is not yet visible within the viewport); and (c) virtualizing the appropriate portion(s) of the content (i.e., returning the content to a form that cannot be directly rendered or displayed).

Scrolling controller 102, in this embodiment, outputs data to be rendered. This data may be stored in a data structure before being consumed by a renderer (not shown) that is used in displaying the GUI (including a scrolling controller having controls such as scrollbars, and a portion of content to be visible within the viewport). In accordance with this embodiment, content-specific scrolling information is separated from the general scrolling controller and operations in order to allow scrolling operations to behave in a manner specific to content (e.g., a command to go up a line can be content-specific to go up by one item in a list rather than going up a pixel of the content, for example) or to make content specific performance optimizations (e.g., only measuring the in-view items in a list).

FIG. 2 illustrates an exemplary viewport with scrollbars (one example of scrolling controls) and their relative positions with respect to content to be scroll-ably displayed in the viewport. In this example, the relative positions of content 200, a viewport 202, a vertical scrollbar 204 and a horizontal scrollbar 206 are illustrated. In some embodiments, the aforementioned layout service provides “layout” dimensions or measurements for the parameters described below.

Content 200, in this exemplary embodiment, is indicated by a rectangle that if completely de-virtualized and displayed would have a height extent 208 and a width extent 210, as indicated by double-headed arrows in the illustration. Height and width extents 208 and 210 can be measured in terms of the number lines and columns, or dots per inch, or other suitable units.

Viewport 202, in this example, has a height denoted viewport height 212 and a width denoted viewport width 214, as indicated by double-headed arrows in the illustration.

In this embodiment, a vertical offset 216 and a horizontal offset 218 are used to define the relative position of content 200 with respect to viewport 202. As indicated by a double-headed arrow in the illustration, vertical offset 216 is the distance from the top of content 200 to the top of viewport 202, in this example embodiment. Horizontal offset 218 represents the distance from the left side of content 200 to the left side of viewport 202, as indicated by another double-headed arrow in the illustration. In other embodiments, the relative position of content 200 with respect to viewport 202 can be defined using different measurements.

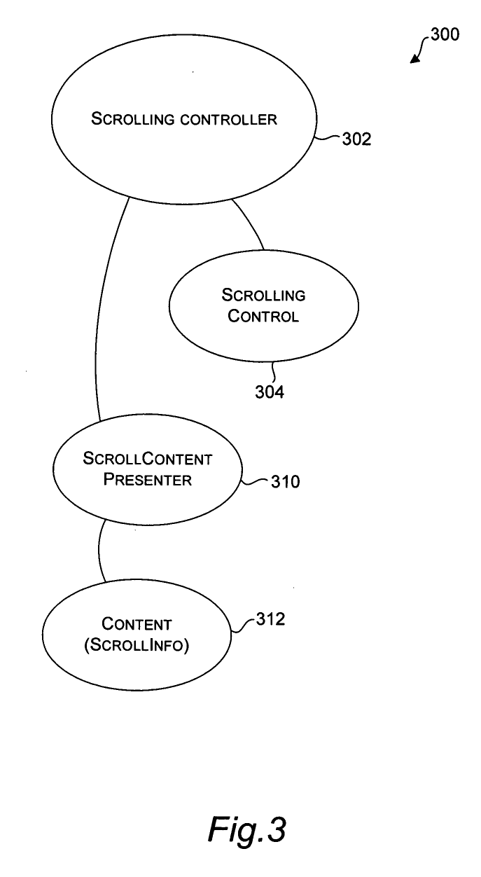

FIG. 3 illustrates an element tree 300 used to describe elements implementing a system to display scrollable content, according to one embodiment. In this embodiment, element tree 300 includes a scrolling controller object 302, at least one scrolling control object 304, a ScrollContentPresenter object 310, and a Content object 312 that implements IScrollInfo.

In one embodiment, the scrolling controller object 302 includes methods, properties and other objects used to implement the functions of scrolling. In such an embodiment, the scrolling controller object 302 is used to process content to be scrollably displayed, layout information from a layout service (not shown), and user input via a user's operation of scrolling controllers (e.g., scrollbars). The scrolling controller object 302 processes the content, layout information and user input (if any) to output data so that it can be scrollably displayed by a renderer (not shown).

ScrollContentPresenter object 310, in one embodiment, is a placeholder for the content and, in addition, can determine whether the content includes information to control parameters used in scrolling. In one embodiment, if ScrollContentPresenter object 310 determines that the content includes the scrolling information (i.e., is an instance of IScrollInfo object 312), ScrollContentPresenter object 310 obtains a reference to the instance of IScrollInfo object 312 and provides it to the scrolling controller object 302. On the other hand, if ScrollContentPresenter object 310 determines that the content does not include scrolling information, then ScrollContentPresenter object 310 provides a reference to itself to the scrolling controller object 302 to support physical scrolling (i.e., conventional scrolling).

In one embodiment, IScrollInfo object 312 can include methods, properties and objects used to implement content processor 106 (FIG. 1). For example, IScrollInfo object 312 can process content to make the appropriate portion of the content visible within the viewport; de-virtualize the appropriate portion(s) of the content; and virtualize the appropriate portion(s) of the content.

In one embodiment, these objects are used in implementing an application program interface (API) that allows developers to use the methods and/or access the properties of the s objects to implement a GUI to scroll content. An exemplary set of API definitions is provided below in Appendix A.

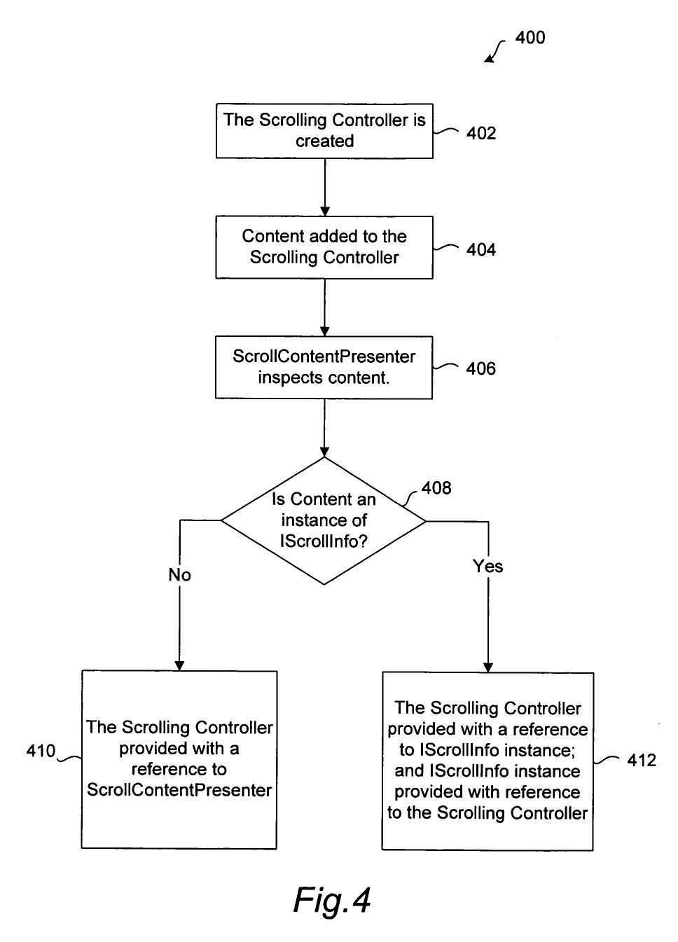

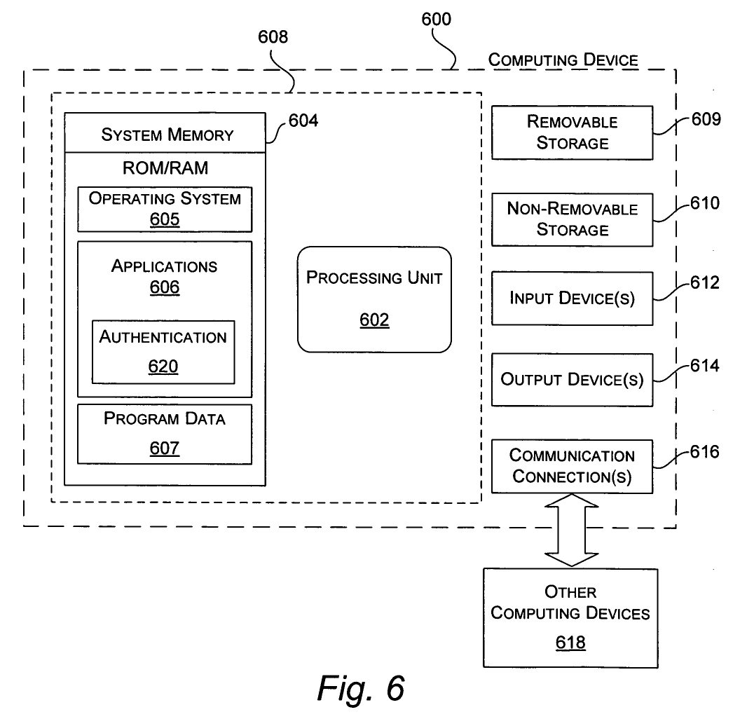

FIG. 4 illustrates an operational flow 400 in creating elements described in element tree 300 (FIG. 3), according to one embodiment. Operational flow 400 may be performed in any suitable computing environment. For example, operational flow 400 may be executed by the computing environment described below in conjunction with FIG. 6 to create a scrolling implementation. However, any such reference to particular components is for descriptive purposes only, and it is to be understood that these components are part of a non-limiting environment for operational flow 400.

At a block 402, a scrolling controller object is created. In one embodiment, an application that is to include a scrolling implementation used in displaying content to a user can instantiate a scrolling controller object. In this embodiment, scrolling controller objects are generic and can be re-used with many different types of scrollable content.

At a block 404, content is added to the scrolling controller object created at block 402. In one embodiment, a user can add content to the scrolling controller, for example, by opening a file or document using the application.

At a block 406, the content is inspected to determine whether the content is to implement content-specific scrolling. In one embodiment, a ScrollContentPresenter object such as ScrollContentPresenter object 310 (FIG. 3) is to inspect the content that was added to the scrolling controller. In this embodiment, content that is to implement content-specific scrolling is an instance of an IScrollInfo object such as IScrollInfo object 312 (FIG. 3). Stated another way, a developer wishing to implement content-specific scrolling would implement the IScrollInfo interface on his content.

At a decision block 408, it is determined whether the content is to specify a scrolling implementation. In this embodiment, the ScrollContentPresenter object determines whether the content is an instance of IScrollInfo. If not, operational flow can proceed to a block 410.

At block 410, a reference to the ScrollContentPresenter object is provided to the scrolling controller. In one embodiment, the ScrollContentPresenter object is an instance of the IScrollInfo. The ScrollContentPresenter object has a reference to the scrolling controller that was provided when the scrolling controller was created at block 402.

However, if back at block 408 it is determined that the content is an IScrollInfo, operational flow 400 proceeds to a block 412. At block 412, a reference to the IScrollInfo is provided to the scrolling controller, and a reference to the scrolling controller is provided to the IScrollInfo. In one embodiment, the ScrollContentPresenter object provides these references to the scrolling controller and the IScrollInfo.

Although operational flow 400 is illustrated and described sequentially in a particular order, in other embodiments, the operations described in the blocks may be performed in different orders, multiple times, and/or in parallel. Further, one or more operations described in the blocks may be omitted or combined in some embodiments.

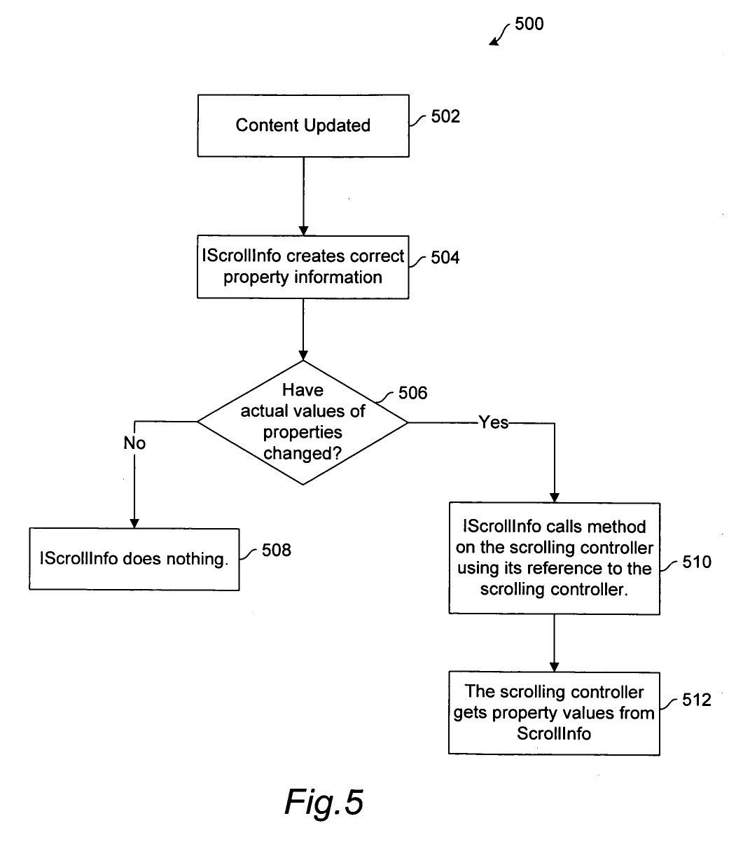

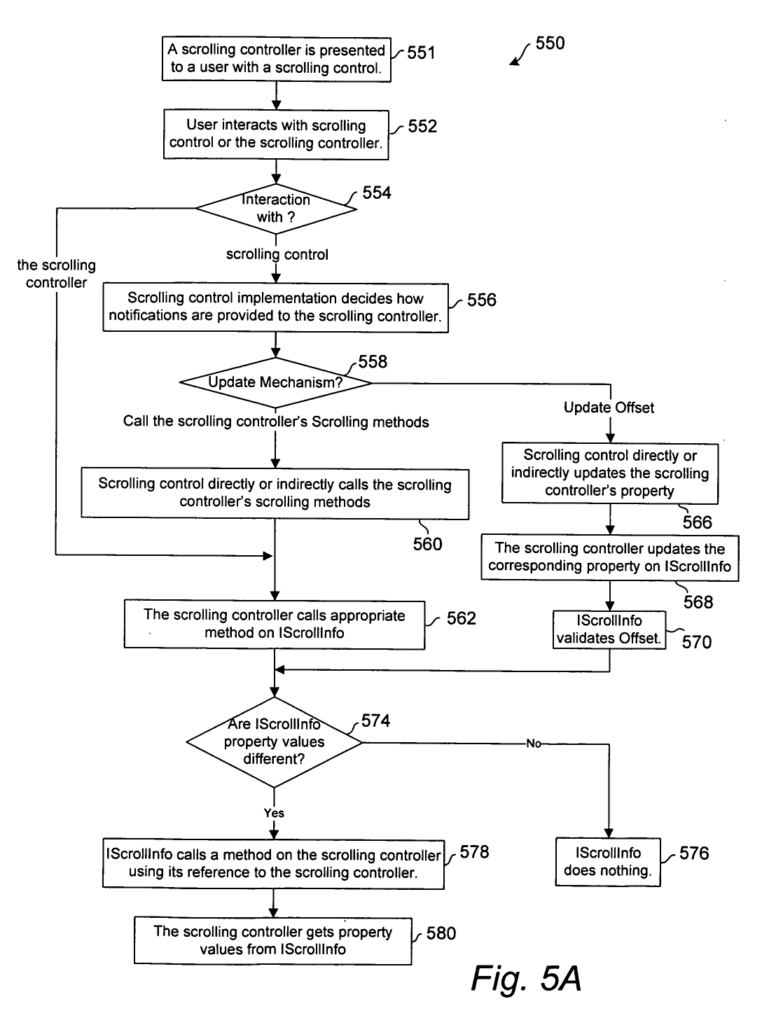

FIG. 5 illustrates an operational flow 500 of a scrolling implementation in response to a content change, according to one embodiment. Operational flow 500 may be performed in any suitable computing environment. For example, operational flow 500 may be executed by the computing environment described below in conjunction with FIG. 6 to create a scrolling implementation. However, any such reference to particular components is for descriptive purposes only, and it is to be understood that these components are part of a non-limiting environment for operational flow 500.

At a block 502, the content is updated. In one embodiment, the content can be updated by a user that is adding or deleting material from the content while the application is running. In addition, the content may be able to change itself (e.g., the content includes an animation). Such changes to the content can result in changes in the content size.

At a block 504, the affected properties of the IScrollInfo are updated. In one embodiment, the IScrollInfo can detect when the content is updated and call a layout service to obtain updated values for properties such as horizontal and vertical extent.

At a block 506, it is determined whether the updated values have actually changed. If no property values have changed as a result of the content change, operational flow 500 can proceed to a block 508 in which IScrollInfo does not perform any operations in response to the updated content. Operational flow 500 can then wait for the content update to return to block 502. However, if at block 506 it is determined that a value of the IScrollInfo property has changed, operational flow 500 can proceed to a block 510.

At block 510, the IScrollInfo causes the scrolling controller to invalidate one or more scrolling-related properties. In one embodiment, the IScrollInfo calls a method on the scrolling controller to invalidate these properties.

At a block 512, the scrolling controller obtains values from the IScrollInfo to update its corresponding properties. In one embodiment, the scrolling controller obtains the values of the updated properties directly from the IScrollInfo using its reference to the IScrollInfo. In addition, in some embodiments, the scrolling controller can propagate these updates to consumers or listeners that can then update their own related properties. For example, the updated values can be propagated to a scrolling control (e.g., scrolling control 104 of FIG. 1) that can then update the position and/or size of a control (e.g., a thumb in a scrollbar). Operational flow 500 can then wait until the next content update to return to block 502.

Although operational flow 500 is illustrated and described sequentially in a particular order, in other embodiments, the operations described in the blocks may be performed in different orders, multiple times, and/or in parallel. Further, one or more operations described in the blocks may be omitted or combined in some embodiments.

FIG. 5A illustrates an operational flow 550 of a scrolling implementation in response to user input, according to one embodiment. Operational flow 550 may be performed in any suitable computing environment. For example, operational flow 550 may be executed by the computing environment described below in conjunction with FIG. 6 to create a scrolling implementation. However, any such reference to particular components is for descriptive purposes only, and it is to be understood that these components are part of a non-limiting environment for operational flow 550.

At a block 551, a scrolling controller (e.g., scrolling controller 102 of FIG. 1) is presented to a user with a scrolling control for use in viewing particular content. As described previously, a scrolling controller may include one or more scrolling controls each with one or more buttons used to allow a user to scroll content. In this embodiment, The scrolling controller can include mechanisms that respond to commands from the user (e.g., by operating an arrow button on the keyboard instead of using a scrollbar). At a block 552, a user can interact with the scrolling control or with the scrolling controller as described above.

At a block 554, it is determined what object is being interacted with by the user. As previously described, in this embodiment, a user can interact with a scrolling control or the scrolling controller. If the user is interacting with the scrolling controller, operational flow 550 can proceed to a block 562, described below. However, if the user is interacting with the scrolling control, operational flow can proceed to a block 556.

At block 556, the scrolling control determines a mechanism to propagate the user's interaction with the scrolling control to the scrolling controller. In this embodiment, the scrolling control can cause method calls to be made on the scrolling controller to propagate the user's interaction with the scrolling control. In addition, the scrolling control can cause a property (e.g., horizontal or vertical offset) to be updated on the scrolling controller. As indicated by a decision block 558, if the scrolling control decides to update a property of the scrolling controller, operational flow 550 can proceed to a block 566 (described below). However, if the scrolling control decides to call methods on the scrolling controller, operational flow 550 can proceed to a block 560 as indicated by block 558.

At block 560, the scrolling control directly or indirectly calls methods on the scrolling controller in response to the user's interaction. For example, in one embodiment the scrolling control can respond to a user's activation of a “LineUp” button implemented on a scrollbar by calling a LineUpCommand method on the scrolling controller. In some embodiments, the scrolling control includes buttons for operations such as LineUp, LineDown, LineLeft, LineRight, PageUp, PageDown, PageLeft, and PageRight. In other embodiments, additional controls may be provided by the scrolling control.

At a block 562, the scrolling controller can then propagate the user's interaction to the IScrollInfo by calling corresponding method on the IScrollInfo. For example, scrolling controller can call a LineUp method on the IScrollInfo in response to a LineUpCommand method call on the scrolling controller by the scrolling control.

Returning to block 558, if the scrolling control decided to update a property of the scrolling controller, operational flow can proceed to block 566.

At block 566, the scrolling control directly or indirectly updates properties on the scrolling controller corresponding to the user's interaction with the scrolling control. For example, if the user moves a thumb of a scrollbar to a new position, then the scrolling control can set the VerticalOffset property on the scrolling controller to update the value of the property to reflect the user's intention.

At a block 568, the scrolling controller then updates the corresponding property on the IScrollInfo. Continuing the example of block 566, in one embodiment the scrolling controller can set the VerticalOffset property on the IScrollInfo.

At a block 570, in response to the scrolling controller updating the property, the IScrollInfo validates the update. For example, the updated value for the property may be outside the allowable range for that property. If the updated value is not valid, the property's value is not changed.

At a decision block 574, it is determined whether the update caused a change in a value of the property. In one embodiment, the IScrollInfo determines whether the values for the vertical or horizontal offset properties have changed. If no value has been changed, operational flow 550 can proceed to a block 576 in which the IScrollInfo does not perform any operations in response to the updated offset property. Operational flow 550 can then wait for the next user interaction with the scrolling control or scrolling controller to return to block 552. However, if at block 574 it is determined that a value of the IScrollInfo has changed, operational flow 550 can proceed to a block 578.

At block 578, the IScrollInfo causes the scrolling controller to invalidate one or more scrolling-related properties. In one embodiment, the IScrollInfo calls an InvalidateScrollInfo method on the scrolling controller to invalidate these properties.

At a block 580, the scrolling controller obtains values from the IScrollInfo to update the corresponding properties in itself. In one embodiment, the scrolling controller obtains the values from the IScrollInfo. In addition, in some embodiments, the scrolling controller can propagate these updates to consumers or listeners that can then update their own related properties. For example, the updated values can be propagated to the scrolling control, which can then update the position and/or size of a control (e.g., a thumb). Operational flow 550 can then wait for the next user interaction with the scrolling control or scrolling controller to return to block 552.

Although operational flow 550 is illustrated and described sequentially in a particular order, in other embodiments, the operations described in the blocks may be performed in different orders, multiple times, and/or in parallel. Further, one or more operations described in the blocks may be omitted or combined in some embodiments.

Illustrative Operating Environment

With reference to FIG. 6, one exemplary system for implementing the invention includes a computing device, such as computing device 600. Computing device 600 may be configured as a client, a server, mobile device, or any other computing device. In a very basic configuration, computing device 600 typically includes at least one processing unit 602 and system memory 604. Depending on the exact configuration and type of computing device, system memory 604 may be volatile (such as RAM), non-volatile (such as ROM, flash memory, etc.) or some combination of the two. System memory 604 typically includes an operating system 605, one or more applications 606, and may include program data 607. This basic configuration is illustrated in FIG. 6 by those components within dashed line 608.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by removable storage 609 and non-removable storage 610. Computer storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of device 600. Computing device 600 may also have input device(s) 612 such as a keyboard, mouse, pen, voice input device, touch input device, etc. Output device(s) 614 such as a display, speakers, printer, etc. may also be included.

Computing device 600 also contains communication connections 616 that allow the device to communicate with other computing devices 618, such as over a network. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Although the invention has been described in language specific to structural features and/or methodological steps, it is to be understood that the invention defined in the appended claims is not necessarily limited to the specific features or steps described. Rather, the specific features and steps are disclosed as forms of implementing the claimed invention. Since many embodiments of the invention can be made without departing from the spirit and scope of the invention, the invention resides in the claims hereinafter appended.

```
APPENDIX A
public interface IScrollInfo
  {
    void LineUp( );
    void LineDown( );
    void LineLeft( );
    void LineRight( );
    void PageUp( );
    void PageDown( );
    void PageLeft( );
    void PageRight( );
    void MouseWheelUp( );
    void MouseWheelDown( );
    void MouseWheelLeft( );
    void MouseWheelRight( );
    void SetHorizontalOffset(double offset);
    void SetVerticalOffset(double offset);
    Rect MakeVisible(Visual v, Rect r);
    bool CanVerticallyScroll { get; set; }
    bool CanHorizontallyScroll { get; set; }
    double ExtentWidth { get; }
    double ExtentHeight { get; }
    double ViewportWidth { get; }
    double ViewportHeight { get; }
    double HorizontalOffset { get; set; }
    double VerticalOffset { get; set; }
    ScrollViewer ScrollOwner { get; set; }
  }
  public enum ScrollBarVisibility
  {
    Disabled = 0,
    Auto,
    Hidden,
    Visible,
  }
  public class ScrollViewer : ContentControl, IScrollProvider
  {
    // Provides ISI / SV separation.
    public virtual IScrollInfo ScrollInfo
    public virtual void InvalidateScrollInfo( )
    // Related to the ScrollContentPresenter
    public bool CanContentScroll
    // Demonstrative of the ISI / SV separation.
    // Reexposure of ISI
    public void LineUp( )
    public void LineDown( )
    public void LineLeft( )
    public void LineRight( )
    public void PageUp( )
    public void PageDown( )
    public void PageLeft( )
    public void PageRight( )
    public double HorizontalOffset { get; set; }
    public double VerticalOffset { get; set; }
    public double ExtentWidth { get; }
    public double ExtentHeight { get; }
    public double ViewportWidth { get; }
    public double ViewportHeight { get; }
    // Scrollbar handling
    public ScrollBarVisibility HorizontalScrollBarVisibility
    public ScrollBarVisibility VerticalScrollBarVisibility
    // External API
    public event ScrollChangedEventHandler ScrollChanged { add;
    remove; }
    public void ScrollToLeftEnd( )
    public void ScrollToRightEnd( )
    public void ScrollToHome( )
    public void ScrollToEnd( )
    public void ScrollToTop( )
    public void ScrollToBottom( )
    // Input handling
    protected override void OnKeyDown(KeyEventArgs e)
    protected override void OnMouseWheel(MouseWheelEventArgs
e)
    protected override void
    OnMouseLeftButtonDown(MouseButtonEventArgs e)
  }
  public ScrollContentPresenter: IScrollInfo
  {
    ....
  }
```

What is claimed is:

1. A computer-implemented process for use in scrolling content, the process comprising:
receiving, by a first component, a reference to a second component, wherein the first component comprises a plurality of properties related to scrolling of the content and the second component comprises a corresponding plurality of properties, wherein one or more of the plurality of properties of the second component are used at least in part to generate data used by a renderer to scrollably display a portion of the content;
changing, by the first component, the value of at least one property of the plurality of properties of the first component to an updated value in response to an input; and
causing, by the first component, the second component to update at least one property of its plurality of properties corresponding to the at least one changed property of the first component, the first component using the reference to cause the updating.

2. The process of claim 1 wherein the input is generated by the second component.

3. The process of claim 2 wherein the input comprises a method call.

4. The process of claim 2 wherein the input is responsive to a user operating a scrolling control.

5. The process of claim 4 wherein the changing, by the first component, the value of at least one property, further comprising validating the updating value.

6. The process of claim 5 further comprising determining whether a value of a property of the plurality of properties has changed.

7. The process of claim 1 wherein the input is responsive to a change in the content.

8. The process of claim 1 wherein the causing, by the first component, the second component to update, further comprises a method call on the second component.

9. At least one computer-readable medium having stored thereon instructions that when executed by a computing device performs operations implementing the process of claim 1.

10. An interface for use in scrolling content, the interface comprising:
a first plurality of accessible properties related to scrolling of the content;
first means, for obtaining a reference to a second object, the second component comprising a second plurality of accessible properties corresponding to the first plurality of accessible properties, wherein one or more of the second plurality of accessible properties are used at least in part to generate data used by a renderer to scrollably display a portion of the content; and
second means, for receiving a first input to change at least one property of the first plurality of accessible properties in response to a second input to the second object.

11. The interface of claim 10 wherein the input is generated by the second component.

12. The interface of claim 10 wherein the first input comprises a method call.

13. The interface of claim 10 further comprising third means, for receiving an updated value to at least one property of the first plurality of accessible properties in response to operation of a scroll control by a user.

14. The interface of claim 10 further comprising fourth means for providing a value of at least one updated property of the first plurality of accessible properties in response to a request.

15. At least one computer-readable medium having stored thereon instructions that when executed implement the interface of claim 10.

16. An interface for use in scrolling content, the interface comprising:
a second plurality of accessible properties related to scrolling of the content;
first means, for receiving a first input that indicates a desired change to at least one property of the second plurality of accessible properties; and
second means, for receiving a second input that indicates at least one property of the first plurality of accessible properties is to change in response to operation of a scrolling control.

17. The interface of claim 16 wherein the first input comprises a method call generated by the scrolling control.

18. The interface of claim 16 wherein the second input comprises a method call generated by a first object having a first plurality of accessible objects corresponding to the second plurality of accessible objects.

19. The interface of claim 16 further comprising third means, for receiving an updated value to at least one property of the second plurality of accessible properties in response to operation of a scroll control by a user.

20. At least one computer-readable medium having stored thereon instructions that when executed implement the interface of claim 16.
